(19) United States
(12) Patent Application Publication
(10) Pub. No.: US 2011/0150670 A1
(43) Pub. Date: Jun. 23, 2011

(54) TRANSMISSION PUMP WITH ONE-WAY CLUTCH FUNCTION AND METHOD OF ASSEMBLING PUMP HUB FOR A TORQUE CONVERTER TO A TRANSMISSION PUMP

(75) Inventors: William BREES, Bay Village, OH (US); Philip GEORGE, Wooster, OH (US); Michael VAN SICKLE, Akron, OH (US); Christopher KRAUSE, Ashland, OH (US); Jeffrey HEMPHILL, Copley, OH (US); Chad MULLEN, Wooster, OH (US)

(73) Assignee: SCHAEFFLER TECHNOLOGIES GMBH & CO. KG, Herzogenaurach (DE)

(21) Appl. No.: 12/973,215

(22) Filed: Dec. 20, 2010

Related U.S. Application Data
(60) Provisional application No. 61/288,507, filed on Dec. 21, 2009.

(51) Int. Cl. F04B 49/02; B23P 17/04

(52) U.S. Cl. 417/214; 29/428

(57) ABSTRACT

A pump for a transmission, including: a housing with a pneumatic port; and a gear for engaging with a pump hub for a torque converter, wherein the pneumatic port is for introducing compressed air into the housing to restrict rotation of the gear. In an example embodiment, restricting rotation of the gear is to prevent rotation of the gear when the gear is interfaced with the pump hub to rotationally lock the gear with the pump hub. A pump for a transmission, including: a housing; a gear for engaging with a pump hub for a torque converter; and, an element for enabling rotation of the gear in a first rotational direction and locking the gear with respect to rotation in a second rotational direction, opposite the first rotational direction. In an example embodiment the element includes a one-way clutch.

### CROSS-REFERENCE TO RELATED APPLICATIONS

This application claims the benefit under 35 U.S.C. §119(e) of U.S. Provisional Application No. 61/288,507, filed Dec. 21, 2009.

### FIELD OF THE INVENTION

The invention relates to a pump for a transmission configured to facilitate assembly to a pump hub for a torque converter and a method for assembling a pump hub for a torque converter to a transmission pump.

### BACKGROUND OF THE INVENTION

To install a torque converter into a transmission it is known to align and then engage an input shaft, stator shaft, and pump gear for the transmission to a turbine hub, stator hub, and impeller hub, respectively, for the torque converter. This process can be difficult and time consuming because of the large number of shafts and hubs that must be properly aligned. If the input shaft, stator shaft, or pump gear and the turbine hub, stator hub, or impeller hub are not properly aligned, it is known to rotate one or more of the misaligned elements with respect to each other and then attempt to engage the an input shaft, stator shaft, pump gear, a turbine hub, stator hub, and impeller hub. However, the relative rotation is hindered by the fact that misaligned and engaged elements tend to rotate together due to frictional engagement of the elements during attempted installation.

### BRIEF SUMMARY OF THE INVENTION

According to aspects illustrated herein, there is provided a method for assembling a pump hub for a torque converter with a pump for a transmission, including: introducing compressed air into the pump for the transmission such that rotation of a gear for the pump for the transmission is restricted; and bringing the pump hub and the gear into mating engagement. In an example embodiment, bringing the pump hub and the gear into mating engagement includes engaging a plurality of indentations proximate a distal end of the pump hub with a plurality of protrusions for the gear. In an example embodiment, bringing the pump hub and the gear into mating engagement includes rotating the pump hub to align the pump hub and the gear.

In an example embodiment, aligning the pump hub and the gear includes aligning a plurality of indentations proximate a distal end of the pump hub with a plurality of protrusions for the gear. In an example embodiment, the pump for the transmission includes at least one opening or line for the intake or expulsion of fluid by the pump and introducing compressed air into the pump includes introducing the compressed air through the at least one opening or line of the pump. In an example embodiment, the pump for the transmission includes a pneumatic port and introducing compressed air into the pump includes introducing the compressed air through the pneumatic port. In an example embodiment, the pump for the transmission is installed on the transmission prior to bringing the pump hub and the gear into mating engagement.

According to aspects illustrated herein, there is provided a method for assembling a pump hub for a torque converter with a pump for a transmission, including: moving the pump for the transmission into engagement with the pump hub; and matingly engaging a gear for the pump for the transmission with the pump hub, such that the gear and the pump hub are rotatable in unison, wherein the pump is not connected to the transmission. In an example embodiment, matingly engaging a gear for the pump with the pump hub includes engaging a plurality of indentations proximate a distal end of the pump hub with a plurality of protrusions for the gear.

In an example embodiment, matingly engaging a gear for the pump with the pump hub includes rotating the gear to align the pump hub and the gear. In an example embodiment, aligning the pump hub and the gear includes aligning a plurality of indentations proximate a distal end of the pump hub with a plurality of protrusions for the gear. In an example embodiment, the method includes installing the transmission pump on the transmission.

According to aspects illustrated herein, there is provided a pump for a transmission, including: a housing with a pneumatic port; and a gear for engaging with a pump hub for a torque converter, wherein the pneumatic port is for introducing compressed air into the housing to restrict rotation of the gear. In an example embodiment, restricting rotation of the gear is to prevent rotation of the gear when the gear is interfaced with the pump hub to rotationally lock the gear with the pump hub. In an example embodiment, preventing rotation of the gear when the gear is interfaced with the pump hub includes preventing rotation of the gear when the pump hub is interfaced with the gear and the pump hub is rotated.

According to aspects illustrated herein, there is provided a pump for a transmission, including: a housing; a gear for engaging with a pump hub for a torque converter; and, an element for enabling rotation of the gear in a first rotational direction and locking the gear with respect to rotation in a second rotational direction, opposite the first rotational direction. In an example embodiment, the element includes a one-way clutch. In an example embodiment, the housing includes a first surface for engagement with a second surface of the transmission and one of the first or second surfaces includes a plurality of features oriented in the second direction and arranged to engage the other of the first or second surface for relative rotation of the pump hub and the gear in the second rotational direction and to slide over the other of the first or second surface for rotation in the first direction.

It is a general object of the present invention to provide an assembly, a pump for a transmission, and a method for facilitating connection of a torque converter to a transmission.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a cross-sectional view of an assembly including a torque converter and a pump for a transmission;

FIG. 3 is a detail of a surface of the pump or transmission shown in FIG. 2;

FIG. 4 is a cross-sectional view of an assembly including a torque converter and a pump for a transmission; and,

FIGS. 5-7 illustrate a method for assembling a pump hub for a torque converter with a pump for a transmission.

### DETAILED DESCRIPTION OF THE INVENTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

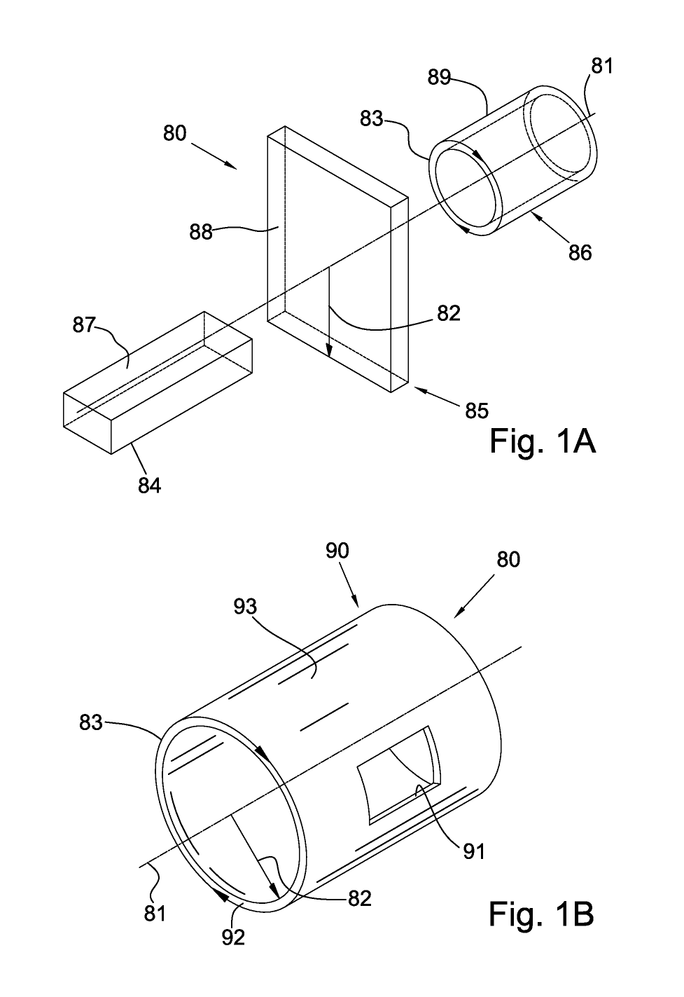

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

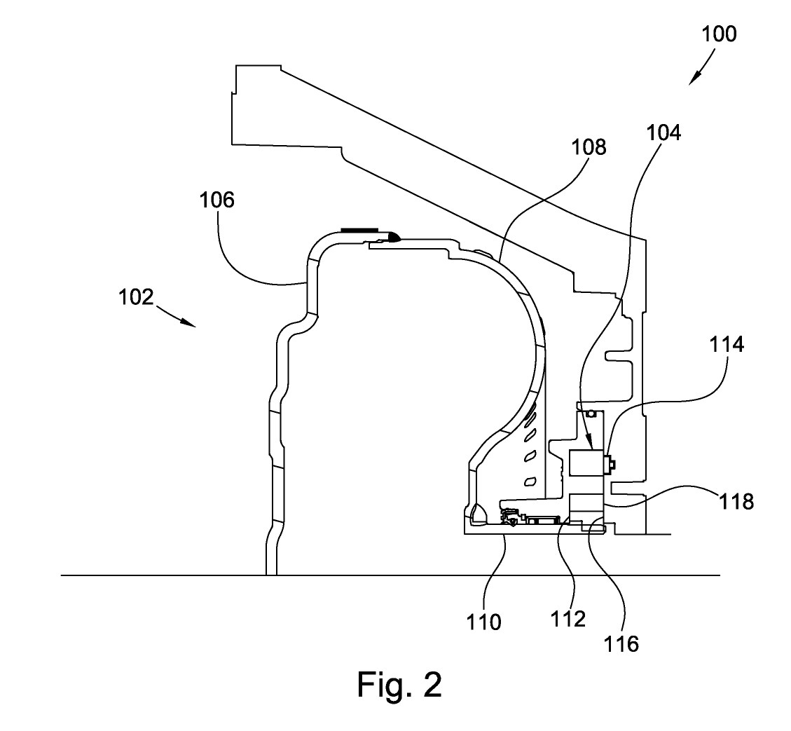

FIG. 2 is a cross-sectional view of assembly 100 including torque converter 102 and pump 104 for a transmission. Cover 106 for the torque converter is connected to pump shell 108, which is in turn connected to pump hub 110. The pump hub is engaged with gear 112 for pump 104 by any means known in the art. The assembly includes an element for enabling rotation of the gear in a first rotational direction and locking the gear with respect to rotation in a second rotational direction, opposite the first rotational direction.

In an example embodiment, the element is one-way clutch 114. Clutch 114 can be any one-way clutch known in the art. In one embodiment, clutch 114 is a strut type one-way clutch as is known in the art, for example, as shown in U.S. Pat. No. 5,070,978, incorporated by reference herein. Clutch 114 enables rotation of the gear in the first direction and prevents rotation of the gear in the second direction.

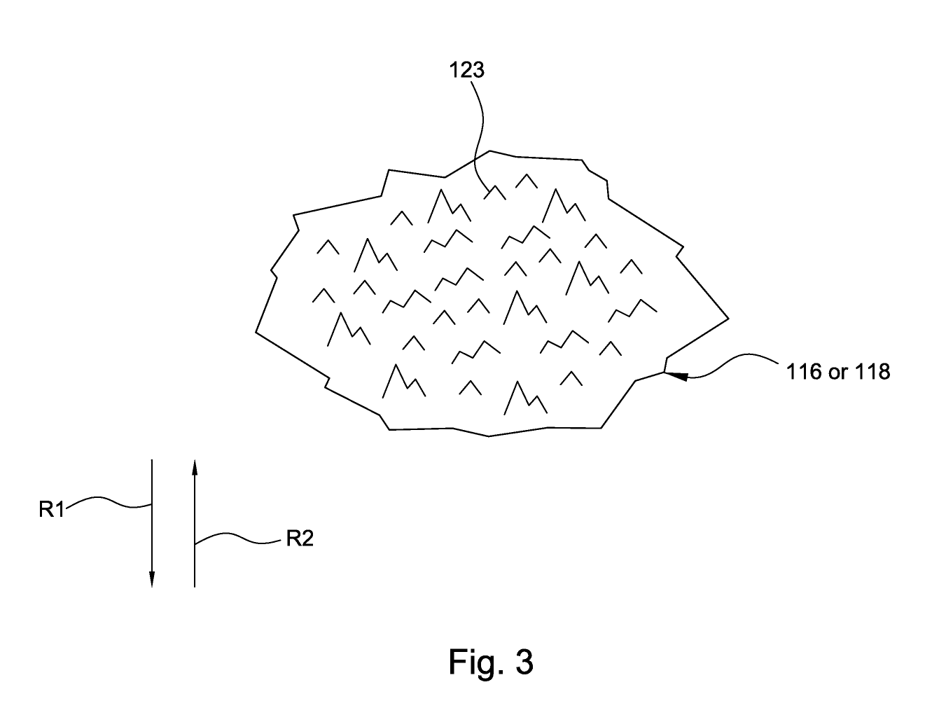

FIG. 3 is a detail of a surface of the pump or transmission shown in FIG. 2. Surface 116 for pump 104 and surface 118 for bell housing 122 are in contact. In an example embodiment, surface 116 is for gear 112. In an example embodiment, one surface 116 or 118 include plurality 123 of features oriented in direction R2 and arranged to engage the other of surface 116 or 118 for relative rotation of the pump hub and the gear in direction R2 and to slide over the other of surface 116 or 118 for rotation in direction R1. That is, the engagement of features 123 for relative rotation in direction R2 locks surfaces 116 and 118 together. Features 123 can be any such features known in the art.

Advantageously, by limiting rotation of the gear to one direction, relative rotation of the gear and the pump hub is facilitated, addressing the problem noted supra regarding the gear and the pump hub rotating together during attempted assembly. For example, if a first attempt at connecting the pump hub and the gear is unsuccessful, for example, the gear and the pump hub are out of alignment, the pump hub can be rotated while still engaged with the gear to bring the gear and the pump hub into alignment. Thus, the assembly process is greatly facilitated, since it is not necessary to completely disengage the pump hub and the gear to adjust alignment.

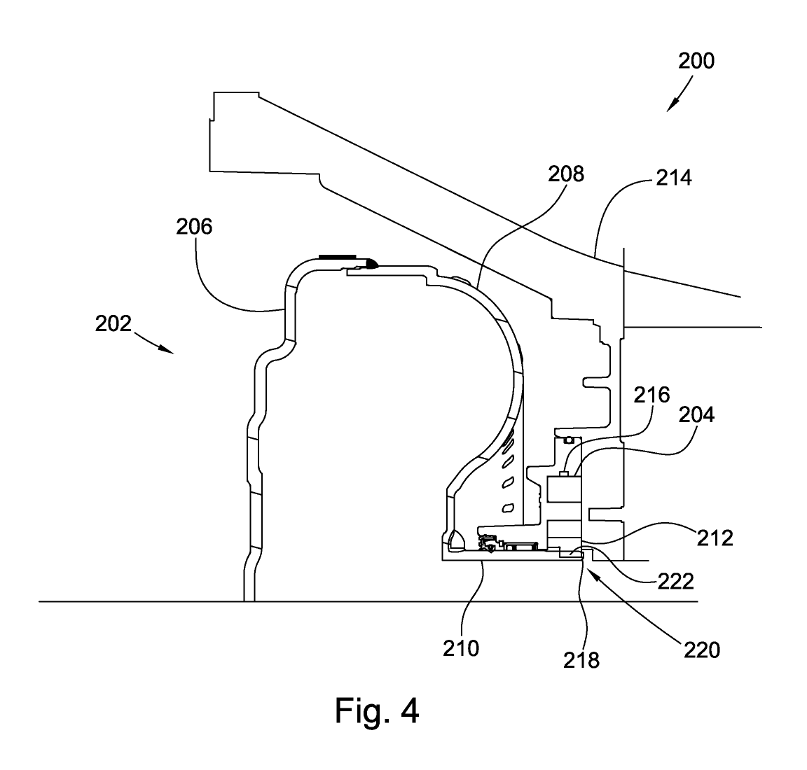

FIG. 4 is a cross-sectional view of assembly 200 including torque converter 202 and pump 204 for a transmission. Cover 206 for the torque converter is connected to pump shell 208, which is in turn connected to pump hub 210. The pump hub is engaged with gear 212 for pump 204 by any means known in the art. Pump 204 is fixed to bell housing 214. Pump 204 includes port 216.

In an example embodiment, port 216 is a pneumatic port, which can be any pneumatic port known in the art. Using pneumatic port 216, compressed air can be introduced, or injected, into pump 204 prior to assembling torque converter 200 and pump 204. By injecting compressed air into pump 204, relative rotation of the gear and the pump hub is facilitated, addressing the problem noted supra regarding the gear and the pump hub rotating together during assembly. For example, if a first attempt at connecting the pump hub and the gear is unsuccessful, for example, the gear and the pump hub are out of alignment, the pump hub can be rotated while still engaged with the gear to bring the gear and the pump hub into alignment. Thus, the assembly process is greatly facilitated, since it is not necessary to completely disengage the pump hub and the gear to adjust alignment. After the pump hub and the gear are matingly engaged, the compressed air can be released and the pump filled with fluid.

In an example embodiment, port 216 is an opening or line for the intake or expulsion of fluid by the pump, for example, designed to feed fluid from the transmission to the pump. Passage or valve body 216 is used to inject the compressed air into the pump. After the pump hub and the gear are matingly engaged, the compressed air is released and passage or valve body 216 is used to feed fluid to the pump.

A method for assembling a torque converter and a pump for a transmission using compressed air is as follows. Although the method is presented in a sequence for clarity, no order should be inferred from the sequence unless explicitly stated. In an example embodiment, the method is used with assembly 200. Pump 204 is connected to bell housing 214 using any means known in the art. Pump 204 is charged with compressed air via port 216. The pump hub and the gear are brought into mating engagement, for example, by moving one or both of the torque converter or the bell housing. In an example embodiment, the pump hub includes indentations 218 at distal end 220 of the pump hub and the gear includes protrusions 222, and the indentations and protrusions are brought into mating engagement. For example, protrusions 222 slide into indentions 218 or indentions 218 slide over protrusions 222. The indentations and protrusions can be any number, configuration, and shape of indentations and protrusions known in the art. Via the mating engaging of the pump hub and the gear, the pump hub and the gear are rotatable in unison.

In an example embodiment, injecting compressed air into the pump causes the pump gear to rotate to facilitate engagement of the pump hub and gear.

In some instances, the pump hub and gear are misaligned when the pump hub and the gear are brought into engagement, preventing mating engagement of the pump hub and gear. For example, the protrusions and the indentations are not sufficiently aligned. By charging pump 204 with compressed air, relative rotation of the gear and the pump hub is facilitated by inhibiting or blocking rotation of the gear. Therefore, the pump hub can be rotated, while the gear is rotationally locked by the compressed air, to place the pump hub and gear into better alignment. That is, the locking of the gear enables relative rotation between the pump hub and the gear. After the pump hub and the gear are matingly engaged, the compressed air can be released and the pump filled with fluid.

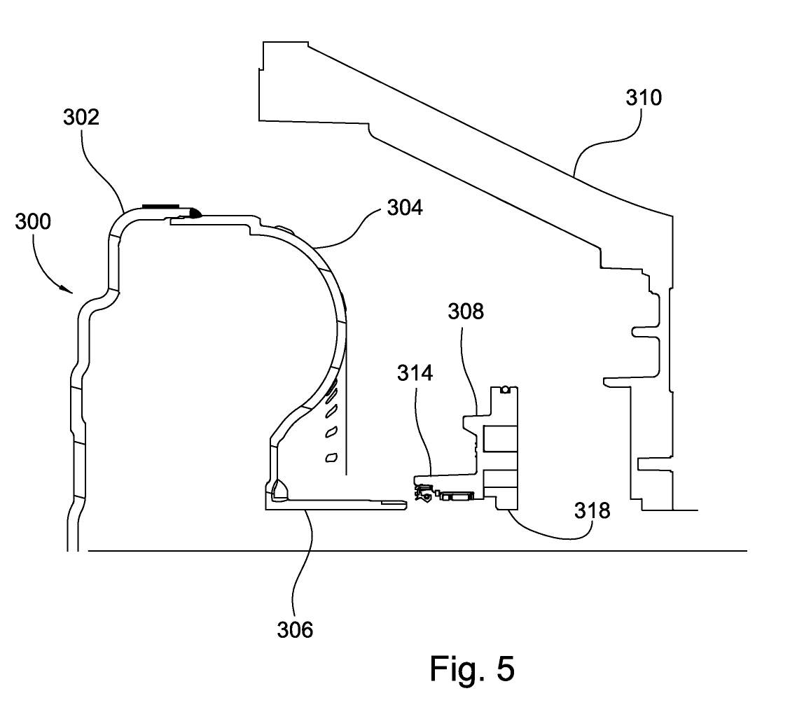

FIGS. 5-7 illustrate a method for assembling a pump hub for a torque converter with a pump for a transmission. Although the method is presented in a sequence for clarity, no order should be inferred from the sequence unless explicitly stated. As shown in FIG. 5, torque converter 300 with cover 302, pump shell 304, and pump hub 306 is initially separate from pump 308 for a transmission (bell housing 310 for the transmission is shown). The cover and pump shell and the pump shell and pump hub are fixedly connected, respectively, so that the cover, the pump shell, and the pump hub are fixed with respect to rotation.

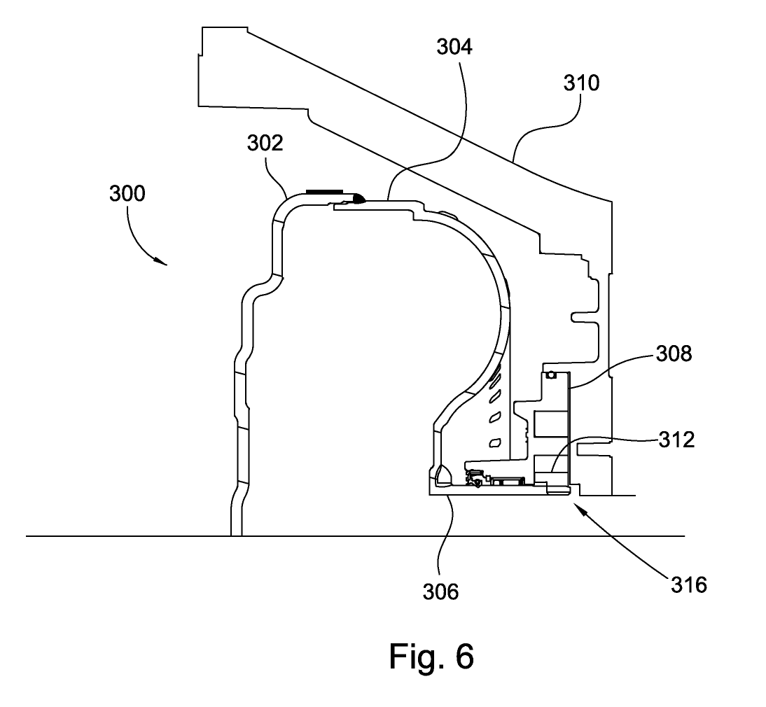

As shown in FIG. 6, the pump hub and gear 312 for pump 308 are brought into mating engagement, for example, by moving one or both of the pump hub and gear. In an example embodiment, the pump hub includes indentations 314 at distal end 316 of the pump hub and the gear includes protrusions 318, and the indentations and protrusions are brought into mating engagement. For example, protrusions 318 slide into indentions 313 or indentions 314 slide over protrusions 318. The indentations and protrusions can be any number, configuration, and shape of indentations and protrusions known in the art. Via the mating engaging of the pump hub and the gear, the pump hub and the gear are rotatable in unison.

In some instances, the pump hub and gear are misaligned when the pump hub and the gear are brought into engagement, preventing mating engagement of the pump hub and gear. For example, the protrusions and the indentations are not sufficiently aligned. The pump hub or the gear can be rotated to place the pump hub and gear into better alignment. Since the pump is separate from the transmission and the gear is easily accessible, an initial rotation of the gear and possible iterative rotations of the gear can be quickly and easily implemented to adequately align the pump hub and the gear. For example, the gear can be rotated to align the indentations and the protrusions. Advantageously, by assembling the torque converter and pump for the transmission as separate components, the number of variables, for example, shafts and hubs that must be properly aligned, are reduced and the parts, for example the gear for the transmission pump, can easily be manipulated.

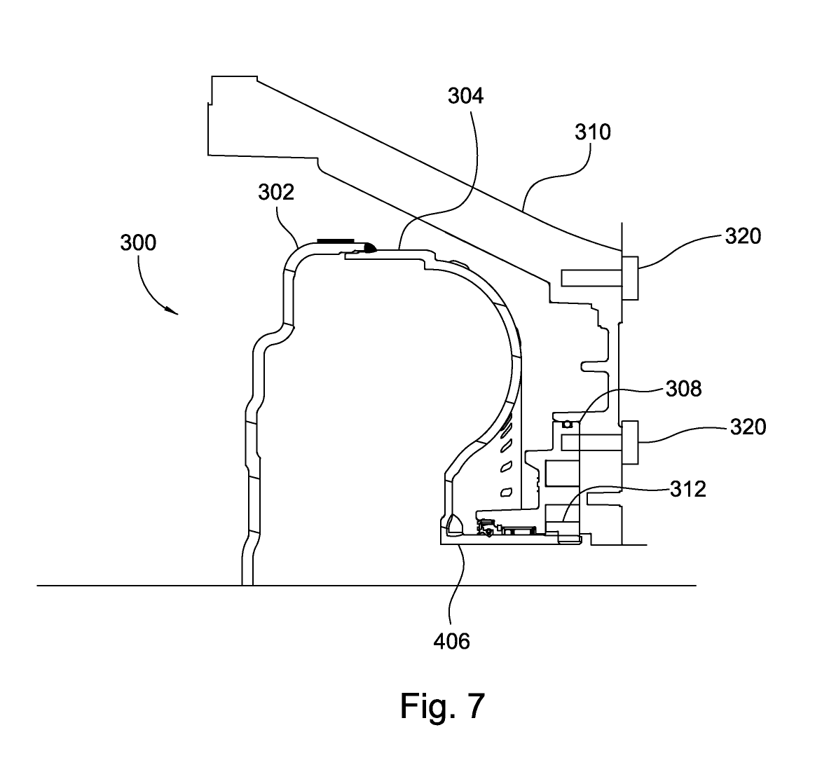

FIG. 7 illustrates connecting the pump for the transmission to the transmission. In FIG. 7, torque converter 300 is connected to pump 308 as described above. Fasteners 320, which can be any fasteners known in the art, are used to connect pump 308 to the bell housing.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A method for assembling a pump hub for a torque converter with a pump for a transmission, comprising:
introducing compressed air into the pump for the transmission such that rotation of a gear for the pump is restricted; and,
bringing the pump hub and the gear into mating engagement.

2. The method of claim 1 wherein bringing the pump hub and the gear into mating engagement includes engaging a plurality of indentations proximate a distal end of the pump hub with a plurality of protrusions for the gear.

3. The method of claim 1 wherein bringing the pump hub and the gear into mating engagement includes rotating the pump hub to align the pump hub and the gear.

4. The method of claim 3 wherein aligning the pump hub and the gear includes aligning a plurality of indentations proximate a distal end of the pump hub with a plurality of protrusions for the gear.

5. The method of claim 1 wherein:
the pump for the transmission includes at least one opening or line for intake or expulsion of fluid by the pump; and,
introducing compressed air into the pump includes introducing the compressed air through the at least one opening or line of the pump.

6. The method of claim 1 wherein:
the pump for the transmission includes a pneumatic port; and,
introducing compressed air into the pump includes introducing the compressed air through the pneumatic port.

7. The method of claim 1 wherein the pump for the transmission is installed on the transmission prior to bringing the pump hub and the gear into mating engagement.

8. A method for assembling a pump hub for a torque converter with a pump for a transmission, comprising:
moving the pump for the transmission into engagement with the pump hub; and,
matingly engaging a gear for the pump for the transmission with the pump hub, such that the gear and the pump hub are fixed with respect to rotation, wherein the pump is not connected to the transmission.

9. The method of claim 8 wherein matingly engaging a gear for the pump with the pump hub includes engaging a plurality of indentations proximate a distal end of the pump hub with a plurality of protrusions for the gear.

10. The method of claim 8 wherein matingly engaging a gear for the pump with the pump hub includes rotating the gear to align the pump hub and the gear.

11. The method of claim 8 further comprising installing the transmission pump on the transmission.

12. A pump for a transmission, comprising:
a housing with a pneumatic port; and,
a gear for engaging with a pump hub for a torque converter, wherein the pneumatic port is for introducing compressed air into the housing to restrict rotation of the gear.

13. The pump of claim 13 wherein restricting rotation of the gear is to prevent rotation of the gear when the gear is interfaced with the pump hub to rotationally lock the gear with the pump hub.

14. The pump of claim 13 wherein preventing rotation of the gear when the gear is interfaced with the pump hub includes preventing rotation of the gear when the pump hub is interfaced with the gear and the pump hub is rotated.

15. A pump for a transmission, comprising:
a housing;
a gear for engaging with a pump hub for a torque converter; and,
an element for enabling rotation of the gear in a first rotational direction and locking the gear with respect to rotation in a second rotational direction, opposite the first rotational direction.

16. The pump of claim 15 wherein the element includes a one-way clutch.

17. The pump of claim 16 wherein the one-way clutch is a strut-type one-way clutch.

18. The pump of claim 15 wherein:
the housing includes a first surface for engagement with a second surface of the transmission; and,
one of the first or second surfaces includes a plurality of features oriented in the second direction and arranged to engage the other of the first or second surface for relative rotation of the pump hub and the gear in the second rotational direction and to slide over the other of the first or second surface for rotation in the first direction.
